(19) United States
(12) Patent Application Publication
(10) Pub. No.: US 2013/0105711 A1
(43) Pub. Date: May 2, 2013

(54) LED curing system

(71) Applicant: Brian A. Eustace, Sierra Madre, CA (US)

(72) Inventor: Brian A. Eustace, Sierra Madre, CA (US)

(73) Assignee: American Ultraviolet Co. Inc.

(21) Appl. No.: 13/317,886

(22) Filed: Nov. 1, 2011

(51) Int. Cl. B01J 19/12

(52) U.S. Cl. 250/492.1

(57) ABSTRACT

A substrate curing system wherein a single LED generates light having a maximum peak wavelength of 377 nm and wherein the generated light is directed to the proximal end of a liquid light guide, the light output from the distal end of the light guide being directed to the surface of the substrate.

### BACKGROUND OF THE INVENTION

1. Field of the Invention

The present invention relates to a device for curing photosensitive materials utilizing light generated by light emitting diodes and directed to the material by using light guide.

2. Description of the Prior Art

U.S. Pat. No. 7,802,910, issued on Sep. 28, 2010 in the name of Kirk A. Middlemass et al, discloses a light guide exposure device comprising light emitting diodes arranged in an array and a flexible light guide having a proximal end and a distal end; the proximal end defining a proximal end diameter. The array is positioned in substantial alignment with the light guide proximal end to direct substantially all of the light from the array to the proximal end. There is no optical element between the light emitting diodes and the proximal end.

Although the LED array disclosed in the '910 patent emit non-collimated light at a maximum wavelength in the range from about 360 nm to about 420 nm, the commercial version of the device utilizes an LED array that produces a peak output wavelength of approximately 390 nm. This wavelength contains a significant amount of infra-red radiation which typically generates significant heat into the material being cured. In addition, the '910 system operates without an optical element between the LED array and the light guide purportedly to avoid reduced transmittance to the light guide

U.S. Publication No. 2004/0152038 to Kumagai et al, published on Aug. 5, 2004 discloses a light irradiation apparatus for a dental photo polymerization composite resin which can polymerize and cure the dental photo polymerization composite resin with a structure such that there are arranged a blue ray radiation LED having luminous wavelengths peaked at a wavelength between 450 nm and 490 nm, and a near ultraviolet rays and/or violet rays radiation LED having luminous wavelengths peaked at a wavelength between 370 nm and 410 n,. A circuit changing switch simultaneously turns on these two kinds of LEDs and turns on only the near ultraviolet rays and/or violet rays radiation LED. An optical elements is positioned between the LED's and the light guide.

Although the prior art discloses systems for curing a substrate using LEDs, they are typically more costly and less efficient than what is commercially desirable.

What is desired is to provide a LED based curing device that is more efficient and less expensive than prior art curing devices.

### SUMMARY OF THE INVENTION

The present invention provides a device for curing photosensitive materials using a single LED device generating a wavelength peaked at 377 nm, a liquid light guide having proximal and distal ends, and an optical element positioned between the LED and the proximal end of the light guide.

The device more particularly, comprises an axial cooling fan that covers a metal heatsink, a single monolithic LED generating a peak wavelength in the range between 365 and 390 nm, a thermistor, a lens optical cover, a liquid light guide holder and a liquid light guide positioned within said holder and a lock to secure the light guide within the holder.

The LED produces illumination having a minimum amount of infra-red, and means are provided for controlling the substrate curing time and adjusting the intensity of the output illumination from 0% to 100%.

### DESCRIPTION OF THE DRAWINGS

For a better understanding of the present invention as well as other objects and further features thereof, reference is made to the following description which is to be read in conjunction with the accompanying drawing therein:

FIG. 1 illustrates a partial perspective view of the curing system of the present invention;

FIG. 2 is an assembly view of the device shown in FIG. 1; and

FIG. 3 is a flowchart illustrating the operation of the curing system of the present invention.

### DESCRIPTION OF THE INVENTION

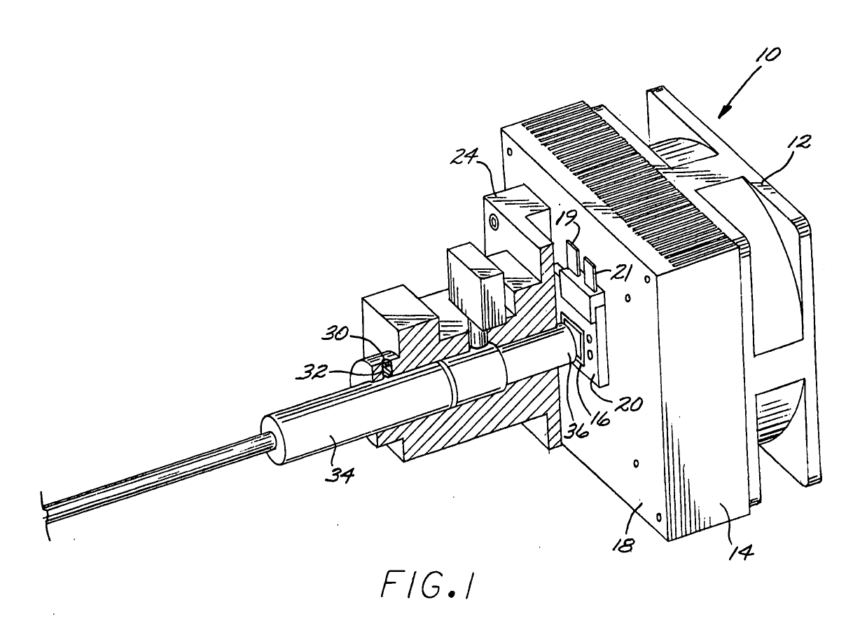

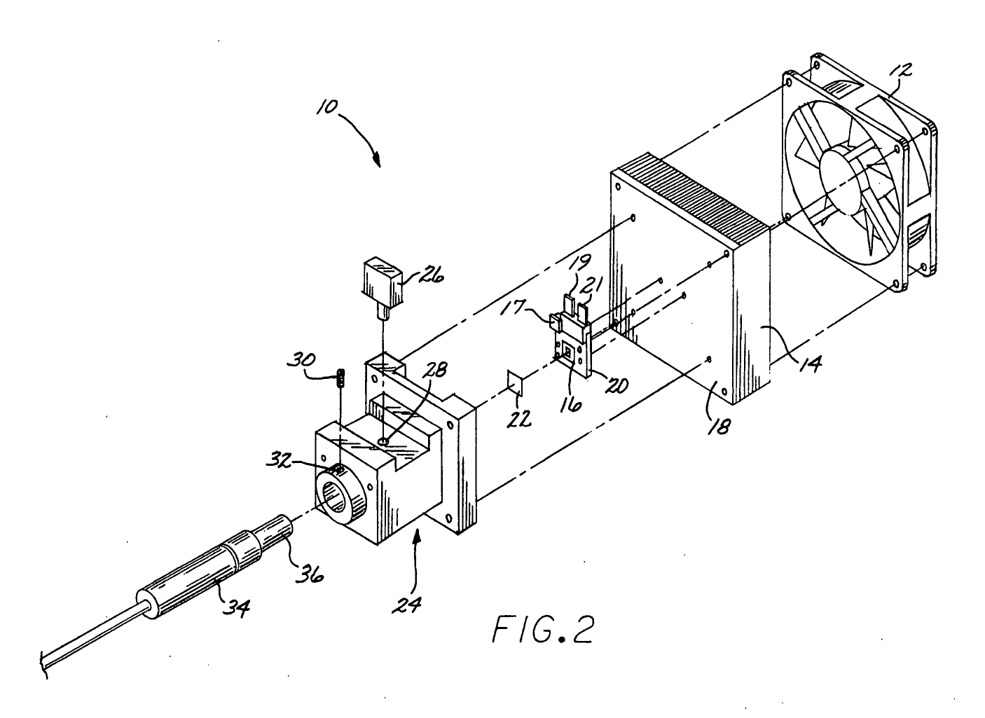

Referring now to FIGS. 1 and 2, curing system 10 comprises a DC axial fan 12 comprising intake and exhaust sections is mounted to one surface of metal (preferably aluminum heatsink 14, a single monolithic LED 16 mounted to surface 18 of heatsink 14, an optical lens cover 22 being positioned over LED 16. A light guide holder 24 is secured to surface 18 of heatsink 14 via a plurality of fasteners (not shown). A microswitch interlock 26 is positioned within aperture 28 formed in holder 24 and detects whether or not a light guide is inserted into holder 24; if a light guide is not inserted, the LED will be prevented from turning on for safety reasons. A friction lock screw 30 is inserted into threaded aperture 32 formed in holder 24 to secure light guide 34 therein in a manner whereby the proximal end 36 of guide 34 is positioned adjacent the emitting surface of LED 16.

Thermistor 7, attached to LED 16, is used in a voltage divider connected to the microchip 20, the microchip 20 using the thermistor to calculate the temperature of the LED 16. The microchip turns fan 12 on/off at certain temperatures and also includes an overheat failsafe to turn off LED 16.

Prongs 19 and 21 are the cathode and anode terminals, respectively, of LED 16 and a DC voltage (approximately 6 volts) is applied when the LED is energized. A large current (approximately 20 amps) is generated which produces the ultraviolet light.

The main system components set forth hereinabove which have been successfully utilized in the system of the present invention are furnished by the following vendors:

| | Part/Model No. | Manufacturer |
|---|---|---|
| DC Axial fan 12 | 74K4027 | Newmark Electronics |
| LED 16 | CBT-120UV-375 | Luminus Devices, Inc. |

(mounting plate 20 incorporates as a single unit LED 16, optical lens
cover 22 and thermistor 17).

| | | |
|---|---|---|
| Light guide holder 24 | 15B1028 | American Ultraviolet Co. |
| Light guide 34 | Series 300 | Lumatec |

The liquid light guide preferably used in device 10 does not have any fibers, but is constructed of epoxy with liquid inside and solid quartz tips at both the proximal and distal ends.

Device 10 also provides enhanced cooling since cooling fan 12 covers substantially the entire back surface of heat sink 14.

The power requirements of device 10 is 90-260 VAC, 50/60 Hz which is furnished to fan 12; the VAC is also connected to DC and applied to LED 16 and LED 16, LED 16 being activated by a footswitch (not shown). The footswitch directly turns LED 16 on/off in the continuous and manual modes, the functions being controlled through the microchip 20. A digital timer and meter (not shown) are integrated into the microchip 20 and enable a user to determine how long LED 16 will remain on or off per cycle.

Means are also provided to adjust the light output intensity from 0% (off) to 100% (full on). A current regulation circuit board (not shown) is designed around an integrated circuit and limits the current going to LED 16 based on the value of an attached adjustable potentiometer. At the minimum value of the potentionmeter ther is no current; at the maximum setting, 20 amps of current is provided. The light outside is directly related to the current driver through LED 16.

A control board has a microprocessor mounted thereto (not shown), the microprocessor controlling when LED 16 is on/off, when the fan is on/off, user input and output and associated safety systems. The microprocessor also provides an on/off signal to the current regulation circuit board. A microprocessor that has been successfully utilized is one sold by Microchip Technology, Part No. PIC 16F877-04L.

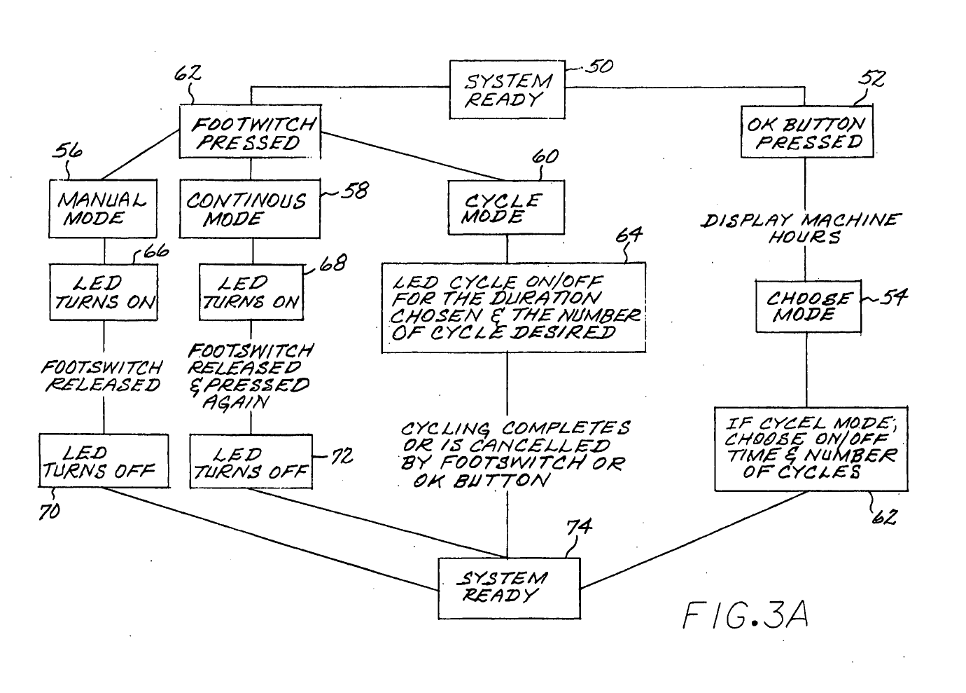

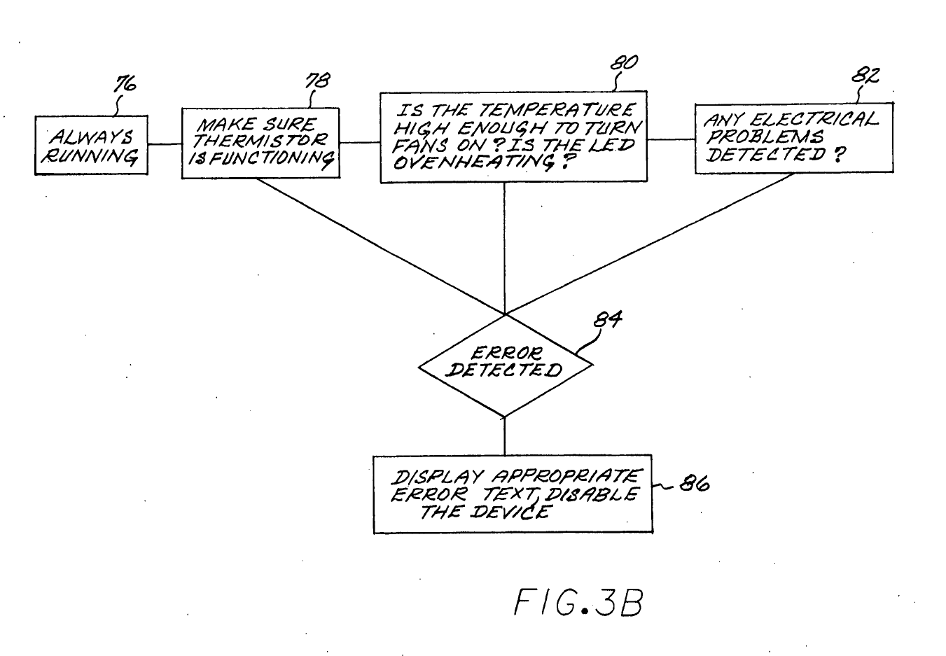

FIG. 3 illustrates, in a flowchart format, how system 10 operates. In particular, when system 10 is ready (block 50), an OK button (block 52) is pressed to initially display how many hours LED 16 has been on and the user then chooses the system mode of operation (block 54), either the manual (block 56), continuous (block 58) or cycle (block 60) mode. The mode is selected by the user by pressing footswitch 62. If the cycle mode is selected (blocks 62, 64), LED 16 cycles on/off for the durations chosen by the user and the desired number of cycles. In the manual and continuous modes, LED 16 is turned on (blocks 66, 68) by the footswitch; in the manual mode, LED 16 is turned off by releasing the footswitch (block 70) and in the continuous mode, the footswitch is pressed after initially being released which then turns off LED 16 (block 72). In the cycle mode, LED 16 is turned off when the cycling is completed and cancelled by the footswitch or pressing the OK button. After LED 16 is turned off, the system is ready for the next operation (block 74).

A number of diagnostic checks are performed when system 10 is running (block 76). These include insuring that thermistor 7 is functioning (block 78), that the temperatures are high enough to turn on fan 12, whether LED 16 is overheating (block 80) and whether electrical problems have been detected (block 82). A detected error (block 84) is displayed on a monitor and system 10 is disabled (block 86).

While the invention has been described with reference to its preferred embodiments, it will be understood by those skilled in the art that various changes may be made and equivalents may be substituted for elements thereof without departing from the true spirit and scope of the invention. In addition, many modifications may be made to adapt a particular situation or material to the teachings of the invention without departing from its essential teachings.

What is claimed is:

1. A device for curing a substrate comprising:
a light source formed of a single LED;
a liquid light pipe spaced from said light source for transmitting light from said LED to said substrate;
a heat sink;
cooling means attached to said heat sink; and
means for securing said LED to said heat sink.

2. The device of claim 1 wherein said LED emits light at a maximum peak wavelength in the range between 365 nm and 420 nm.

3. The device of claim 2 wherein said LED emits light at a maximum peak wavelength of approximately 377 nm.
